(19) United States
(12) Patent Application Publication
(10) Pub. No.: US 2018/0061523 A1
(43) Pub. Date: Mar. 1, 2018

(54) THERMALLY CONDUCTIVE ELECTRICAL INSULATION MATERIAL

(71) Applicant: 3M INNOVATIVE PROPERTIES COMPANY, St. Paul, MN (US)

(72) Inventors: Mitchell T. Huang, Austin, TX (US); Robert H. Turpin, Hill, NH (US)

(21) Appl. No.: 15/678,200

(22) Filed: Aug. 16, 2017

Related U.S. Application Data
(60) Provisional application No. 62/379,514, filed on Aug. 25, 2016.

(51) Int. Cl. H01B 3/52; C09K 5/14; D21H 13/26; D21H 13/18; D21H 17/37; D21H 17/67; D21H 17/68; B32B 27/10

(52) U.S. Cl. CPC H01B 3/52; C09K 5/14; D21H 13/26; D21H 13/18; H01B 3/421; D21H 17/67; D21H 17/68; D21H 17/675; B32B 27/10; D21H 17/37

(57) ABSTRACT

A thermally conductive, electrical insulating paper having a thermal conductivity greater than 0.4 W/m-K is described. The thermally conductive, electrical insulating paper is a nonwoven paper that comprises aramid fibers, an aramid pulp, a binder material; and a synergistic blend of thermally conductive fillers, wherein the synergistic blend comprises a primary thermally conductive filler; and a secondary thermally conductive filler.

### BACKGROUND OF THE INVENTION

### Field of the Invention

This invention relates to materials suitable for electrical insulation applications. In particular, this invention relates to electrical insulation materials suitable for transformers, motors, generators, and other electrical devices. In particular, the present technology relates to a thermally conductive electrical insulating material having a synergistic blend of thermally conductive fillers.

### Background

Heat is an undesirable by-product of electrical transformers, motors, generators, and other electrical devices. Higher operating temperatures typically reduce device lifetime and reliability as well as impose design constraints on the actual device design. The electrical insulation materials, such as conventional electrical insulating papers, used in electrical transformers, motors, and generators often are poor thermal conductors and can limit heat dissipation of the device.

Improving the thermal transfer performance of an electrical device can provide lower temperature increases with conventional electrical device designs or can enable new smaller electrical device designs. Lower device operating temperatures provide improved reliability according to the Arrhenius equation which infers that a 10° C. increase in operating temperature cuts the lifetime of the insulation materials in half. Lower device operating temperatures can also improve the efficiency of the electrical device by reducing the resistive (Joule heating) losses. Lower device operating temperatures may also enable the electrical device to run at higher power levels or provide higher overload capacity. Lower temperature rise could also enable device redesign to more compact device sizes and more efficient use of raw materials by using less amount of metal which could reduce total device system cost.

Thermal transfer performance can be improved by changing the heat transfer media to one having a higher thermal conductivity or by replacing materials that have high thermal resistances to materials having lower thermal resistance or a higher thermal conductivity.

Papers employed for electrical insulation include Kraft or cellulose based papers, organic papers, inorganic/organic hybrid papers, and inorganic papers. Examples of commercially available nonwoven papers suitable for use in the present invention includes those available from 3M Company, USA, under the trade designations CeQUIN, including but not limited to CeQUIN I (about 90% inorganic content), CeQUIN II (two-layer (ply) composites of CeQUIN I), CeQUIN X (enhanced wet strength for B-stage applications), and CeQUIN 3000 (about 74% inorganic content plus organic fiber reinforcement); ThermaVolt inorganic insulating paper, ThermaVolt AR inorganic insulating paper, FLAME BARRIER FRB including, but not limited to, FLAME BARRIER-FRB-NT calendered insulation paper and FLAME BARRIER FRB-NC uncalendered insulation paper. Examples of commercially available electrical insulating materials from DuPont (www2.dupont.com) are available under the trade designation NOMEX, including but not limited to NOMEX Paper Type 410, Type 411 (lower density version), Type 414, Type 418 (includes mica), Type 419 (lower density version of Type 418), and Type E56. Examples of commercially available electrical insulating materials from SRO Group (China) Limited are available under the trade designation X-FIPER; and from Yantai Metastar Special Paper Co., Ltd., China, are available under the trade designation METASTAR.

Many of these conventional papers are typically used in high-temperature electrical insulation applications in which thermal stability, electrical properties and the mechanical properties of these papers are important.

Conventional electrical insulating papers typically have a thermal conductivity of 0.25 W/m-K or less. When these papers are used in electromagnetic coil windings, heat generated in a conductor accumulates and the temperature of the coil rises because the heat cannot be efficiently transported out of the coil winding. As a result of heat build-up, which can be due to the relatively low thermal conductivity of conventional electrical insulating papers, the power density of the coil is restricted.

Thus, higher thermal conductivity of electrical insulation papers are needed that can improve heat dissipation and provide lower device operating and hot spot temperatures in electrical transformers, motors, generators, and other electrical devices.

### SUMMARY

There is a need in certain electrical insulation applications for materials with higher thermal conductivity that achieve suitable performance in electrical equipment applications.

The materials of the present invention are suitable for insulating electrical components in transformers, motors, generators, and other devices requiring insulation of electrical components.

At least some embodiments of the present invention provide a thermally conductive, electrical insulating paper. The thermally conductive, electrical insulating paper is a nonwoven paper that comprises aramid fibers, an aramid pulp, a binder material; and a synergistic blend of thermally conductive fillers, wherein the synergistic blend comprises a primary thermally conductive filler; and a secondary thermally conductive filler. The paper can additionally include at least one of acrylic fibers, a low thermally conductive inorganic filler, such as a kaolin clay and a flame retardant.

In other embodiments, a thermally conductive, electrical insulating paper comprises 20 wt. %-30 wt. % organic components, wherein a portion of the organic components are fibrous; and 70 wt. %-80 wt. % inorganic components wherein a portion of the inorganic component is a synergistic blend of thermally conductive fillers, wherein the synergistic blend comprises a primary thermally conductive filler; and a secondary thermally conductive filler. The organic components comprises a combination of polymer fibers, a polymer pulp, and binder material. And in some aspect, the paper includes a combination of para-aramid fibers, acrylic fibers; a para-aramid pulp and an acrylic latex binder material. In some embodiments the inorganic components further include at least one of low thermally conductive fillers, inorganic flame retardants, and inorganic pigments.

In an exemplary aspect, the first thermally conductive filler is a high thermal conductivity filler having a thermal conductivity greater than or equal to 40 W/m-K, and the second thermally conductive filler is a low thermal conductivity filler having a thermal conductivity less than 40 W/m-K. In some embodiments, the first thermally conductive filler is boron nitride and the second thermally conductive filler is at least one of silica, alumina and ATH. The thermal conductivity of the exemplary papers, described herein, is greater than 0.4 W/m-K.

In an exemplary aspect, the exemplary papers are cellulose free and as such the papers have a high thermal stability suitable for use in electrical insulation system thermal classes 155 (Class F), 180 (Class H), 200 (Class N), and 220 (Class R).

As used in this specification:

“Cellulose free” means containing only trace amounts of cellulose-based material, for example, containing less than 0.5 wt. % cellulose-based material, preferably containing less than 0.1 wt. % cellulose-based material, more preferably containing no cellulose-based material;

“Directly fused” means having no intervening layer such as an adhesive layer;

“Nonwoven paper” means a sheet material primarily comprised of short fibers;

“Short fibers” means fibers less than one inch long;

“MD” or “machine direction” refers to the direction parallel to the windup direction of a continuous sheet of material; and

“Other inorganic filler” are inorganic fillers having a thermal conductivity less than 0.6 W/m-K.

An advantage of at least one embodiment of the nonwoven papers, described herein, is that it achieves a thermal conductivity higher than a material having a single high thermal conductivity filler at the same overall concentration of thermally conductive fillers, while having sufficient dielectric strength as well as good mechanical strength. Another attribute of the disclosed nonwoven papers include high temperature thermal stability, for example, the exemplary materials are suitable for use in electrical insulation system thermal classes 155 (Class F), 180 (Class H), 200 (Class N), and 220 (Class R). The exemplary insulating papers exhibit good flexibility to enable winding or forming within coils, which enables their use in electric transformers, motors, generators, and other devices requiring insulation of electrical components.

The above summary of the present invention is not intended to describe each disclosed embodiment or every implementation of the present invention. The detailed description that follows below more specifically illustrates embodiments of the invention.

### BRIEF DESCRIPTION OF THE DRAWINGS

The invention will be described hereinafter in part by reference to non-limiting examples thereof and with reference to the drawings, in which:

FIG. 1 is a graph showing the enhancement in the thermal conductivity due to the synergistic blend of thermally conductive fillers in the exemplary thermally conductive, electrical insulating papers according to the invention.

FIG. 2 is a graph showing the improvement in thermal conductivity in the exemplary thermally conductive, electrical insulating papers according to the invention by comparing calculated and measure relative thermal conductivity factors.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following description, it is to be understood that other embodiments are contemplated and may be made without departing from the scope of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the present specification and attached claims are approximations that can vary depending upon the desired properties sought to be obtained by those skilled in the art utilizing the teachings disclosed herein. The use of numerical ranges by endpoints includes all numbers and any value within that range (e.g., 1 to 5 includes 1, 1.5, 2, 2.75, 3, 3.80, 4, and 5).

Conventional means of improving the thermal conductivity of a material is to put the highest loading of the highest thermally conductive fillers into the material. High thermal conductivity fillers include fillers that have a thermal conductivity greater than 50 W/m-K and include carbon nanotubes, diamond particles and boron nitride. These high thermal conductivity fillers can be expensive for routine use in insulating papers.

The nonwoven electrically insulating paper of at least some embodiments of the present invention comprises a sheet material made of short fibers, i.e., fibers less than one inch (2.54 cm) long, preferably less than one half inch (1.27 cm). In at least one embodiment of the present invention, the majority of the fibers in the nonwoven paper are organic. However, the exemplary nonwoven papers can include small amounts of inorganic fibers (<5 wt. %).

The exemplary nonwoven paper can include about 15 wt. % to about 50 wt. %, preferably about 20 wt. % to about 30 wt. % organic components, wherein a portion of the organic components are fibrous and about 50 wt. % to about 85 wt. %, preferably about 70 wt. % to about 80 wt. % inorganic components. Organic components can include organic fibers and binder materials. A portion of the inorganic component comprises a synergistic blend of thermally conductive fillers, wherein the synergistic blend comprises a primary thermally conductive filler; and a secondary thermally conductive filler. The inorganic components can also include, other thermally conductive fillers, low thermally conductive fillers, other inorganic fillers, inorganic flame retardants, inorganic pigments and the like.

The nonwoven electrically insulating paper includes a synergistic blend of thermally conductive fillers, wherein the synergistic blend comprises a primary thermally conductive filler; and a secondary thermally conductive filler. The article can be formed as an insulating paper for electrical equipment, such as transformers, motors, generators. Heat is an undesirable by-product of electrical transformers, motors, and generators. Insulating papers of the present invention can be used as layer insulation to insulate successive layers of electrical conductors within the same winding in an electrical transformer. The multiple alternating layers of conductor and insulating paper within a coil winding are one area where heat dissipation is a challenge within an electrical transformer. In an electrical motor or generator, the slot liner electrical insulation is positioned between the heat generating conductor wires and more thermally conductive metal materials. Low thermal conductive slot liner materials will be an area within a motor or generator that can restrict heat dissipation.

The higher thermal conductivity of the exemplary insulating papers described herein can improve heat dissipation out of the electrical devices resulting in lower operating temperatures. In addition, the improved heat dissipation from higher thermally conductive papers may allow reductions in device/coil size where improved heat dissipation/lower operating temperature from the higher thermally conductive papers can help compensate for the increased operating temperature resulting from device size reduction without significantly changing the operating temperature of the device resulting in a smaller size transformer with lower total system material costs.

The exemplary thermally conductive papers, as described herein, or thermally conductive laminates including the exemplary thermally conductive papers also have potential for use as slot liners in electrical motor/generator applications where the slot liners are hand/manually inserted. Motor manufacturers desire higher thermal conductivity slot liner insulation materials for improved heat dissipation in motors/generators. In order to work as a slot liner, the insulating material must have sufficient flexibility so that it can be bent and shaped for insertion into the slots in the motor stator and/or rotor.

For example, a thermally conductive insulating laminate material can include a thermally conductive, electrical insulating paper of the present disclosure that is laminated to a surface of a polymer film. In an exemplary embodiment, the polymer film can be a thermally conductive polymer film, such as is described in U.S. Provisional Patent Application Nos. 62/541,920 and 62/541,929, herein incorporated by reference in their entirety. In another aspect, thermally conductive polymer film can be an oriented film that includes an orientated layer formed of polyethylene terephthalate or polyethylene naphthalate, and substantially spherically alumina particles dispersed within the orientated layer. The alumina particles can be present in an amount from 20 wt. % to 40 wt. % of the orientated film. The alumina particles have a D99 value of 20 micrometers or less, or 15 micrometers or less, or 10 micrometers or less, and a median size value in a range from 1 to 7 micrometers, or from 1 to 5 micrometers, or from 1 to 3 micrometers.

In an alternative embodiment, the thermally conductive insulating material can have the thermally conductive, electrical insulating paper laminated to both surfaces of the thermally conductive polymer film. Optionally, a laminating adhesive layer can be disposed between the thermally conductive, electrical insulating paper and the thermally conductive polymer film to bond the layers together.

In some embodiments, higher level laminate constructions are contemplate that include a plurality of alternating thermally conductive, electrical insulating paper and thermally conductive polymer film layers.

Suitable nonwoven papers may include organic fibers such as, but not limited to, aramid fibers, including meta-aramid and para-aramid fibers; polyphenylene sulfide (PPS) fibers; polyester fibers; polyamide fibers, acrylic fibers, melamine fibers, polyetheretherketone (PEEK) fibers, polyimide fibers or a combination thereof. The organic fibers can make up about 40%-80% of the organic component of nonwoven paper. In an exemplary aspect a combination of fibers can be used. The fibers can vary in chemical composition as well as size and can be selected to improve the manufacturability of the exemplary nonwoven paper as well as the final properties. In some embodiment, an aramid fiber, for example a para-aramid fiber can be combined with a non-aramid fiber to form the nonwoven paper of the present disclosure. The ratio of aramid fibers to non-aramid fibers can be from about 15:1 to about 8:1.

At least a portion of the fibrous components can have a high surface area per mass with a surface area greater than 10 m²/g. For example, a high surface area pulp can facilitate retention of the paper slurry in the paper formation process. To increase the surface area of the fibers used in the nonwoven paper, it may be desirable to fibrillate or pulp a portion of the fibers to form a pulp. For example, an aramid fiber pulp can be substituted for a portion of the aramid fibers in the exemplary nonwoven paper. For example, an aramid pulp can be substituted for 60-80% of the aramid fiber in the exemplary paper.

In some aspects, the inorganic component of the electrically insulating nonwoven paper can optionally include a high surface area inorganic fiber such a glass microfiber having an average diameter of about 0.6 μm or less.

In at least one embodiment of the present invention, the organic component of the nonwoven paper also comprises a polymeric binder. The polymeric binder can make up about 25%-60% of the organic component. A suitable polymer binder may include a latex-based material. In another aspect, suitable polymer binders can include, but are not limited to, acrylic, acrylic copolymer, nitrile, styrene latex, guar gum, starch, and natural rubber latex. In one example, the electrically insulating paper comprises from about 7% to about 25% polymer binder by weight.

As mentioned above, the electrically insulating paper comprises a synergistic blend of thermally conductive fillers, wherein the synergistic blend comprises a primary or first thermally conductive filler; and a secondary or second thermally conductive filler. The first thermally conductive filler is a high thermal conductivity filler having a thermal conductivity greater than or equal to 40 W/m-K.

For example, boron nitride is widely classified as a high thermally conductive filler, however, the anisotropy of boron nitride particles results in radically different thermal conductivities depending on which dimension is being referenced. Hexagonal boron nitride platelet particles possess an anisotropic thermal conductivity with reported values of 400 W/m-K in the (xy) basal plane direction and 2 W/m-K in the (z) platelet thickness direction. In a boron nitride particle filled composite material, platelet orientation and particle to particle packing characteristics can influence the measured thermal conductivity of the composite material. An isotropic thermal conductivity of 50 W/m-K has been reported in the literature (P. Bujard et al, Thermal Phenomena in the Fabrication and Operation of Electronic Components: I-THERM '88, InterSociety Conference, pp. 41-49, 1988).

Other high thermal conductivity fillers include aluminum nitride (170 W/m-K), and silicon carbide (360 W/m-K). While metallic particles such as copper particles, iron particles, lead particles and silver particles, to name a few, all have thermal conductivities in excess of 100 W/m-K, their use in the exemplary insulating papers described herein is not possible due to their electrical conductivity. Similarly, graphite and carbon nanotubes cannot be used in the insulating papers of the current invention.

The second conductive filler having a lower thermal conductivity of less than 40 W/m-K can be selected from fused amorphous silica (1.5 W/m-K), zirconia dioxide (˜2 W/m-K), zinc oxide (21 W/m-K), and alumina (26 W/m-K).

In addition, the inorganic component of the electrically insulating nonwoven paper can include another inorganic filler. In one aspect, suitable other inorganic fillers include, but are not limited to, kaolin clay, talc, mica, calcium carbonate, montmorillonite, smectite, bentonite, illite, chlorite, sepiolite, attapulgite, halloysite, vermiculite, laponite, rectorite, perlite, and combinations thereof. These other inorganic fillers may be surface treated to facilitate their incorporation into the exemplary papers. Suitable types of kaolin clay include, but are not limited to, water-washed kaolin clay; delaminated kaolin clay; calcined kaolin clay; and surface-treated kaolin clay. In one example, the electrically insulating paper comprises from about 5% to about 20% kaolin clay by weight.

The inorganic component of the electrically insulating nonwoven paper can optionally include an inorganic flame retardant. The inorganic flame retardant may be any suitable material. Examples of suitable inorganic flame retardant materials include metal hydroxides, e.g., magnesium hydroxide (MgOH) and alumina trihydrate (ATH). The inorganic flame retardant may comprise up to about 20 wt. %, preferably up to about 15 wt. % of the nonwoven paper. In some aspects of the invention, the inorganic flame retardant can have a sufficiently high thermal conductivity such that it can be used as the second thermally conductive filler or as a tertiary or third thermally conductive filler. For example, ATH has a thermal conductivity between 10-30 W/m-K.

Nonwoven papers of the invention containing one or both of inorganic fibers and inorganic particles may be referred to as inorganic based papers. Inorganic based papers provide improved long term voltage endurance in the presence of corona/partial discharge compared to, for example, completely organic based meta-aramid papers because inorganic materials are known to be much more resistant to corona than organic materials. (See, e.g., The Electrical Insulation Conference (EIC)/Electrical Manufacturing and Coil Winding (EMCW) Expo 2001, Cincinnati, Ohio Oct. 2015-Oct. 18, 2001, High Temperature Electrical Insulation Short Course, p. 21). These inorganic based papers can also provide greater dimensional stability as well as higher thermal conductivity for improved heat dissipation compared to, for example, completely organic based meta-aramid papers.

In many of the embodiments, the electrically insulating paper is formed as a nonwoven electrically insulating paper that can be formed via a standard paper process. For example, the elements of the formulation can be mixed as a slurry in water, dewatered on a papermaking screen, and dried. The nonwoven electrically insulating paper can be calendered to produce a high density paper and/or several sheets of the electrically insulating paper can be stacked and calendered to directly fuse adjacent sheets and create a thicker, high density paper. The result is a nonwoven, thermally conductive, electrically insulating paper can be suitable for use in electrical equipment, such as for electrical insulation within a transformer, motor, generator, or other electrical device.

In some embodiments, the exemplary insulating material may further include a film or mesh reinforcement. In one aspect, a relatively thin non-thermally conductive film compared to the thickness of the exemplary electrically insulating, thermally conductive papers described herein can be laminated to the exemplary paper for mechanical or dielectric reinforcement and still result in improved laminate thermal conductivity when compared to conventional insulating paper laminates. For example, a thin polyester film could be laminated to one or both sides of the exemplary papers described herein. The lamination can be a direct lamination of the film to the paper or may further comprise a thin adhesive layer to bond the film to the exemplary paper.

In an alternative aspect, a thermal conductivity films can be laminated to the exemplary thermally conductive paper described herein in order to maximize thermal conductivity of the laminate. Commercially available thermally conductive films include Devinall THB 500 polyimide and Devinall THB 300 Polyimide available from Fastel Adhesive Products (San Clemente, Calif.) and Kapton 200MT polyimide film, Kapton 300MT polyimide film available from DuPont (Wilmington, Del.).

### EXAMPLES

The following examples and comparative examples are offered to aid in the understanding of the present invention and are not to be construed as limiting the scope thereof. Unless otherwise indicated, all parts and percentages are by weight. The following test methods and protocols were employed in the evaluation of the illustrative and comparative examples that follow.

### Materials

| | |
|---|---|
| Acrylic Latex | Hycar 26362 available from The Lubrizol Corp. (Cleveland, OH) |
| Acrylic Fiber | VONNEL 1 MVP available from Mitsubishi Rayon Co. (Japan) |
| p-aramid pulp | TWARON ® Aramid pulp 1094 available from Teijin Aramid |
| | (Netherlands) |
| p-aramid fiber | TWARON ® Aramid fiber 1080 available from Teijin Aramid |
| | (Netherlands) |
| hBN | 3M ™ Boron Nitride Powder Grade S3 available from ESK Ceramics |
| | GmbH & Co. KG, a 3M company (Kempten, Germany) |
| FS-20 | 3M ™ Fused Silica 20 available from 3M Company (St. Paul, MN) |
| FS-44C | Teco-sil 44C Fused Silica available from Imerys Refractory Materials |
| | (Greeneville, TN) |
| Kaolin | Delaminated kaolin clay available from HYDRAPRINT from KaMin, |
| | LLC (Macon, GA) |
| Alumina | Tabular Alumina T60/64-325 LI available from Almatis, Inc. |
| | (Leetsdale, PA) |
| ATH | Micral 9400D available from J. M. Huber Corporation (Atlanta, GA) |
| Calcium | Hubercarb W3N available from J. M. Huber Corporation (Atlanta, GA) |
| carbonate | |

### Sample Preparation:

The exemplary electrically insulating nonwoven papers were made using methods known in the art, as follows:

A mixture of 10 wt. % p-aramid pulp (specific surface area 12-15 m²/g), 1.5 wt. % acrylic fiber (0.1 dtex×3 mm), 3.5 wt. % p-aramid fiber (1.7 denier×6 mm), and 10 wt. % acrylic latex and 75 wt. % fillers provided in Tables 1-5 were dispersed with water to form an aqueous slurry with a solids content of about 0.06-0.9% by weight. Dewatering was done through a papermaking screen and press (Williams Standard Pulp Testing Apparatus). The paper was then dried.

Calendered papers were formed by calendering at a speed of 3 ft/min (0.9 m/min) between steel rolls at a pressure of 1000 PLI (179 kg/cm) and temperature around 370° F. (188° C.)-380° F. (193° C.). Composition information and measured properties for exemplary papers is provided in Tables 1-6.

### Nonwoven/Polymer Film Laminate Preparation

A Mayer rod (#20 wire size) was used to coat a laminating adhesive onto the surface of a polymer film which was then dried in a lab oven for 1 minute at 250° F. (121° C.). A calendered paper layer was then laminated to the film with ROBOND™ L-330/CR 9-101 Laminating Adhesive available from (Dow Chemical Company, Midland Mich.) in a laboratory hot roll laminator (Chemsultants International) at 250° F. (121° C.) and 5 ft/min. This process was repeated to apply a second calendered paper layer the other side of the polymer film to yield a paper/polymer film/paper laminate.

### Test Methodologies

### Thermal Conductivity

Thermal conductivity values were measured with a Unitherm model 2021 guarded heat flow meter according to ASTM E-1530. Measurements were taken at 180° C. Samples were measured without use of any interfacial fluid/material to avoid any potential complications with the interfacial fluid/material penetrating the porous areas of the electrical insulation paper. Without the use of an interfacial fluid, thermal losses at the interface between the test plate surface and the sample material surface will be included in the thermal conductivity measurement which may make the measured thermal conductivity value reported here lower than the actual inherent material's thermal conductivity. Thinner samples were stacked together until the thermal resistance was within the instrument's calibration range. The thermal conductivity of a conventional Nomex® Paper Type 410 available from DuPont Advanced Fibers Systems (Richmond, Va.) was found to be 0.10 W/m-K, and the thermal conductivity of a conventional 3M™ ThermaVolt Calendered Inorganic Insulating Paper Laminates available from 3M Company (St. Paul, Minn.) was found to be 0.2 W/m-K.

### Wrap Flexibility

Wrap flexibility was evaluated visually by wrapping the electrical insulation materials around a 2.54 mm (0.1″) diameter rod to see if there was sufficient flexibility to wrap around the rod without any breakage.

### Moisture Absorption

Samples were placed in an environmental chamber and exposed to the specified aging conditions for 24 hours as provided in Table 9. The percent water content was determined by gravitational analysis and comparison of a dried sample to a sample after the specified exposure.

### Additional Test Methods

Additional mechanical, electrical and physical properties were measured according to the following standardized test procedures.

| PROPERTY | TEST METHOD | TITLE |
|---|---|---|
| Dielectric Strength | ASTM D149-09 | Standard Test Method for Dielectric |
| | | Breakdown Voltage and Dielectric Breakdown |
| | | Strength of Solid Electrical Insulating |
| | | Materials at Commercial Power Frequencies |
| MD Tensile | ASTM D-828-97 | Standard Test Method for Tensile Properties |
| Strength | (2002) | of Paper and Paperboard Using Constant-Rate- |
| | | of-Elongation Apparatus |
| Elongation, MD | ASTM D-828-97 | Standard Test Method for Tensile Properties |
| | (2002) | of Paper and Paperboard Using Constant-Rate- |
| | | of-Elongation Apparatus |
| Tear Strength, CD | ASTM D-689 | Standard Test Method for Internal Tearing |
| | | Resistance of Paper |
| Porosity | TAPPI T-460 | Standard Test Method for Air Resistance |
| | | Tester for Paper (Gurley method) |

Table 1 provides the composition and measured properties for a series of insulating papers having varying amounts of a single high thermal conductive filler (i.e. boron nitride) and another inorganic filler (i.e. kaolin clay). The kaolin clay has been found to help with paper slurry retention during dewatering, so a small amount is included in both the exemplary and comparative example formulations.

TABLE 1
Thermally conductive papers with boron nitride and clay
(compositions are provided in wt. %/vol. %)

| | C1 | C2 | C3 | C4 | C5 | C6 |
|---|---|---|---|---|---|---|
| p-aramid pulp | 10/14.5 | 10/14.2 | 10/13.9 | 10/13.7 | 10/13.5 | 10/13.3 |
| p-aramid fiber | 3.5/5.1 | 3.5/5.0 | 3.5/4.9 | 3.5/4.8 | 3.5/4.8 | 3.5/4.6 |
| Acrylic fiber | 1.5/2.7 | 1.5/2.6 | 1.5/2.6 | 1.5/2.6 | 1.5/2.5 | 1.5/2.5 |
| Acrylic latex | 10/17.4 | 10/17 | 10/16.7 | 10/16.5 | 10/16.2 | 10/15.9 |
| Boron Nitride (S-3) | 0/0 | 15/13.9 | 30/27.3 | 40/35.9 | 50/44.3 | 65/56.4 |
| Kaolin Clay | 75/60.3 | 60/47.2 | 45/34.6 | 35/26.6 | 25/18.7 | 10/7.3 |
| Caliper (mils) | 4.5 | 4.1 | 5.0 | 5.0 | 5.1 | 5.1 |
| Basis weight | 189 | 163 | 200 | 196 | 203 | 195 |
| (grams/cm²) | | | | | | |
| Tensile Strength | 30.3 | 25.2 | 29.1 | 25.7 | 22.6 | 23.6 |
| (lbs/in.) | | | | | | |
| Elongation (%) | 1.61 | 1.52 | 1.51 | 1.51 | 1.31 | 1.4 |
| Dielectric Strength | 602 | 643 | 765 | 847 | 987 | 1162 |
| (volts/mil) | | | | | | |
| Thermal Conductivity | 0.37 | 0.43 | 0.62 | 0.67 | 0.82 | 0.99 |
| (W/m-K) | | | | | | |
| Gurley Porosity | 240 | 200 | 240 | 200 | 200 | 270 |
| (sec/100 cc air) | | | | | | |
| Wrap Flexibility | Yes | Yes | Yes | Yes | Yes | Yes |

Table 2 provides the composition and measured properties for a series of insulating papers having a synergistic blend of two thermal fillers in the presence of a constant amount of another inorganic filler (i.e. kaolin clay). The amounts of the high thermal conductive filler (i.e. boron nitride) and the low thermal conductive filler (i.e. silica) are varied while holding the total inorganic content in the paper constant.

TABLE 2
Thermally conductive papers with boron nitride, fused silica, and clay
(compositions are provided in wt. %/vol. %)

| | Ex. 1 | Ex. 2 | Ex. 3 |
|---|---|---|---|
| p-aramid pulp | 10/13.3 | 10/13.3 | 10/13.3 |
| p-aramid fiber | 3.5/4.6 | 3.5/4.6 | 3.5/4.6 |
| Acrylic fiber | 1.5/2.5 | 1.5/2.5 | 1.5/2.5 |
| Acrylic latex | 10/15.9 | 10/15.9 | 10/15.9 |
| Boron Nitride (S-3) | 0/0 | 15/13.0 | 50/43.4 |
| FS-20 | 65/56.4 | 50/43.4 | 15/13.0 |
| Kaolin Clay | 107.3 | 10/7.3 | 10/7.3 |
| Caliper (mils) | 5.1 | 4.8 | 4.9 |
| Basis weight (gram/cm²) | 197 | 199 | 195 |
| Tensile Strength (lbs/in.) | 26.3 | 27.5 | 25.8 |
| Elongation (%) | 1.83 | 1.60 | 1.66 |
| Dielectric Strength (volts/mil) | 274 | 400 | 911 |
| Thermal Conductivity (W/m-K) | 0.38 | 0.47 | 0.89 |
| Gurley Porosity (sec/100 cc air) | 184 | 184 | 220 |
| Wrap Flexibility | Yes | Yes | Yes |

Table 3 provides the composition and measured properties for a series of insulating papers having a synergistic blend of two thermal fillers in the presence of a constant amount of another inorganic filler (i.e. kaolin clay) and ATH. The amounts of the high thermal conductive filler (i.e. boron nitride) and the low thermal conductive filler (i.e. silica) are varied while holding the total inorganic content in the paper constant.

TABLE 3
Thermally conductive papers with boron nitride, fused silica, ATH, and clay
(compositions provided in wt. %/vol. %)

| | Ex. 4 | Ex. 5 | Ex. 6 | Ex. 7 | Ex. 8 |
|---|---|---|---|---|---|
| p-aramid pulp | 10/13.4 | 10/13.4 | 10/13.4 | 10/13.4 | 10/13.4 |
| p-aramid fiber | 3.5/4.7 | 3.5/4.7 | 3.5/4.7 | 3.5/4.7 | 3.5/4.7 |
| Acrylic fiber | 1.5/2.5 | 1.5/2.5 | 1.5/2.5 | 1.5/2.5 | 1.5/2.5 |
| Acrylic latex | 10/16.1 | 10/16.1 | 10/16.0 | 1016.0 | 10/16.0 |
| Boron Nitride (S-3) | 0/0 | 10/8.8 | 15/13.1 | 15/13.1 | 30/26.2 |
| FS-20 | 50/43.9 | 40/35.1 | 40/35.0 | 0/0 | 25/21.9 |
| FS-44C | 0/0 | 0/0 | 0/0 | 40/35.0 | 0/0 |
| ATH | 15/12.0 | 15/12.0 | 10/7.9 | 10/7.9 | 10/7.9 |
| Kaolin Clay | 10/7.4 | 10/7.4 | 10/7.4 | 107.4 | 10/7.4 |
| Caliper (mils) | 4.8 | 4.9 | 5.1 | 5.2 | 5.53 |
| Basis weight (gram/cm²) | 187 | 189 | 208 | 207 | 212 |
| Tensile Strength (lbs/in.) | 26.8 | 26.0 | 27.0 | 27.8 | 25.7 |
| Elongation (%) | 1.82 | 1.76 | 1.50 | 1.60 | 1.52 |
| Dielectric Strength | 299 | 349 | 391 | 355 | 439 |
| (volts/mil) | | | | | |
| Thermal Conductivity | 0.43 | 0.58 | 0.56 | 0.60 | 0.80 |
| (W/m-K) | | | | | |
| Gurley Porosity (sec/100 cc | 185 | 201 | 186 | 162 | 244 |
| air) | | | | | |
| Wrap Flexibility | Yes | Yes | Yes | Yes | Yes |

Table 4 provides the composition and measured properties for a series of insulating papers having a synergistic blend of two thermal fillers in the presence of a constant amount of another inorganic filler (i.e. kaolin clay). The amounts of the high thermal conductive filler (i.e. boron nitride) and a low thermal conductivity filler/flame retardant (i.e. ATH) are varied while holding the total inorganic content in the paper constant.

TABLE 4
Thermally conductive papers with boron nitride, ATH, and clay
(compositions provided in wt. %/vol. %)

| | Ex. 9 | Ex. 10 | Ex. 11 |
|---|---|---|---|
| p-aramid pulp | 10/13.7 | 10/13.5 | 10/13.1 |
| p-aramid fiber | 3.5/4.8 | 3.5/4.7 | 3.5/4.6 |
| Acrylic fiber | 1.5/2.5 | 1.5/2.5 | 1.5/2.5 |
| Acrylic latex | 10/16.5 | 10/16.2 | 10/15.8 |
| Boron Nitride (S-3) | 15/14.1 | 30/27.7 | 50/45.0 |
| ATH | 50/40.8 | 35/28.0 | 15/11.7 |
| Kaolin Clay | 10/7.6 | 10/7.4 | 107.3 |
| Caliper (mils) | 4.9 | 4.9 | 5.1 |
| Basis weight (gram/cm²) | 195 | 189 | 203 |
| Tensile Strength (lbs/in.) | 25.4 | 21.7 | 25.2 |
| Elongation (%) | 1.73 | 1.51 | 1.66 |
| Dielectric Strength (volts/mil) | 406 | 469 | 923 |
| Thermal Conductivity (W/m-K) | 0.59 | 0.74 | 0.98 |
| Gurley Porosity (sec/100 cc air) | 228 | 240 | 256 |
| Wrap Flexibility | Yes | Yes | Yes |

Table 5 provides the composition and measured properties for a series of insulating papers having a synergistic blend of two thermal fillers in the presence of a constant amount of another inorganic filler (i.e. kaolin clay) and ATH. The amounts of the high thermal conductive filler (i.e. boron nitride) and the low thermal conductive filler (i.e. alumina) are varied while holding the total inorganic content in the paper constant. Clay has been found to help with paper slurry retention so a small amount is included in the formulations.

TABLE 5
Thermally conductive papers with boron nitride, alumina, ATH, and clay
(compositions provided in wt. %/vol. %)

| | Ex. 12 | Ex. 13 |
|---|---|---|
| p-aramid pulp | 10/15.6 | 10/13.9 |
| p-aramid fiber | 3.5/5.5 | 3.5/4.9 |
| Acrylic fiber | 1.5/2.9 | 1.5/2.6 |
| Acrylic latex | 10/18.8 | 10/16.7 |
| Boron Nitride (S-3) | 15/16.1 | 40/38.2 |
| Alumina | 40/23.1 | 15/7.7 |
| ATH | 10/9.3 | 10/8.3 |
| Kaolin Clay | 10/8.7 | 10/7.7 |
| Caliper (mils) | 4.7 | 5.1 |
| Basis weight (gram/cm²) | 212 | 210 |
| Tensile Strength (lbs/in.) | 23.9 | T20.9 |
| Elongation (%) | 1.6 | 1.44 |
| Dielectric Strength (volts/mil) | 362 | 631 |
| Thermal Conductivity (W/m-K) | 0.61 | 0.68 |
| Gurley Porosity (sec/100 cc air) | 235 | 280 |
| Wrap Flexibility | Yes | Yes |

Table 6 provides the composition and measured properties for a series of insulating papers having a synergistic blend of two thermal fillers in the presence of another inorganic filler (i.e. kaolin clay). The amounts of the high thermal conductive filler (i.e. boron nitride) and the low thermal conductive filler (i.e. calcium carbonate or calcium carbonate and ATH) are varied while holding the total inorganic content in the paper constant.

TABLE 6
Thermally conductive papers with boron nitride, calcium carbonate,
ATH, and clay; boron nitride, calcium carbonate, and clay
(compositions provided in wt. %/vol. %)

| | Ex. 14 | Ex. 15 |
|---|---|---|
| p-aramid pulp | 10.0/14.2 | 10/13.6 |
| p-aramid fiber | 3.5/5.0 | 3.5/4.7 |
| Acrylic fiber | 1.5/2.7 | 1.5/2.5 |
| Acrylic latex | 10/17.1 | 10/16.3 |
| Boron Nitride (S-3) | 10/9.8 | 40/37.2 |
| Calcium carbonate | 30/22.8 | 20/14.5 |
| ATH | 15/12.7 | 0/0 |
| Kaolin Clay | 20/15.8 | 15/11.3 |
| Caliper (mils) | 4.7 | 4.7 |
| Basis weight (gram/cm²) | 195 | 178 |
| Tensile Strength (lbs/in.) | 33.3 | 30 |
| Elongation (%) | 2.0 | 2.1 |
| Dielectric Strength (volts/mil) | 647 | 938 |
| Thermal Conductivity (W/m-K) | 0.56 | 0.80 |
| Gurley Porosity (sec/100 cc air) | | 320 |
| Wrap Flexibility | Yes | Yes |

Table 7 shows data of three paper/polymer film/paper laminate constructions (Ex. 16-Ex. 18) that were made by laminating the thermally conductive paper of Ex. 14 to the designated polymer film. The films used were a standard polyester (PET) film, such as Hostaphan 2262 available from Mitsibushi Polyester Film (Greer, S.C.), ARYAPET A460 available from JBF RAK LLC (United Arab Emerites), and Series 777 and 860 polyester films from 3M Company (St. Paul, Minn.); a high thermal conductivity polyester film (HTCD PET) film, such as is described in U.S. Provisional Patent Application No. 62/541,920, herein incorporated by reference; and a polyimide film such as Devinall™ 500 THB Polyimide film available from Fastel Adhesive & Substrate Products (San Clemente, Calif.).

TABLE 7
Thermally conductive paper/polymer film/paper laminate materials

| | Ex 16 | Ex 17 | Ex 18 |
|---|---|---|---|
| Film layer | PET | HTCD PET | PI |
| Film thickness (mils/μm) | 2.0/51 | 2.0/51 | 5.0/127 |
| Laminate Caliper (mils) | 8.0 | 7.2 | 12 |
| Basis weight (gram/cm²) | 295 | 279 | 466 |
| Tensile Strength (lbs/in.) | 74 | 51 | 108 |
| Elongation (%) | 6.7 | 5.6 | 6.1 |
| CD Tear Strength | 336 | 208 | 400 |
| Dielectric Strength (volts/mil) | 1352 | 1219 | 1017 |
| Thermal Conductivity (W/m-K) | 0.29 | 0.39 | 0.37 |

Table 8 shows properties of commercially available, inorganic based paper laminates. The commercial paper laminates included in Table 8 are 3M™ ThermaVolt TvFTv Flexible Laminates available from 3M Company (St. Paul, Minn.). For reference, additional electrical insulation laminates, such as, Nomex-Mylar-Nomex (3-3-3), such as NMN 333 NOMEX® Laminate Type NMN, available from Dupont (Wilmington, Del.), were measured to have a thermal conductivity value of 0.12 W/mK.

TABLE 8
Select properties of commercial inorganic based paper laminates

| | | TvFTv | TvFTv |
|---|---|---|---|
| Physical Properties | TvFTv 3-1-3 | 4-2-4 | 3-3-3 |
| Nominal Thickness (mil) | 7 | 10 | 9 |
| Basis Weight (lbs/yd²) | 254 | 388 | 327 |
| Machine Direction Tensile (lbs/in.) | 52 | 87 | 101 |
| Cross Direction Tensile (lbs/in.) | 33 | 63 | 77 |
| Machine Direction Elongation (%) | 2 | 3 | 3 |
| Cross Direction Elongation (%) | 3 | 3 | 3 |
| Machine Direction Tear (g) | 170 | 400 | 480 |
| Cross Direction Tear (g) | 200 | 498 | 588 |
| Moisture absorption (%) | <1 | <1 | <1 |
| Dielectric Breakdown Voltage (kV) | 7.6 | 11 | 11 |
| Thermal Conductivity (W/m · K) | 0.19 | 0.21 | |

Moisture (water) absorption content was determined for an exemplary paper (EX. 14) and exemplary laminate construction (Ex. 17) and a conventional paper (NOMEX® Type 410-3 mil) and a conventional laminate material (NMN 333 NOMEX® Laminate Type NMN), both available from Dupont (Wilmington, Del.).

TABLE 9
Comparison of Moisture Absorption of an exemplary thermally
conductive insulating paper and laminate material to a
conventional insulating paper and laminate material

| | Aging Conditions | | |
|---|---|---|---|
| | Relative Humidity | Temperature | Moisture absorption |
| EX. 14 | 45% | 22° C. | 0.6% |
| Ex. 14 | 95-99% | 26° C. | 1.4% |
| Ex. 17 | 95-99% | 26° C. | 1.7% |
| Nomex ™ 410 | 45% | 22° C. | 2.7% |
| Nomex ™ 410 | 45% | 26° C. | 6.6% |
| NMN 333 | 95-99% | 26° C. | 2.6% |

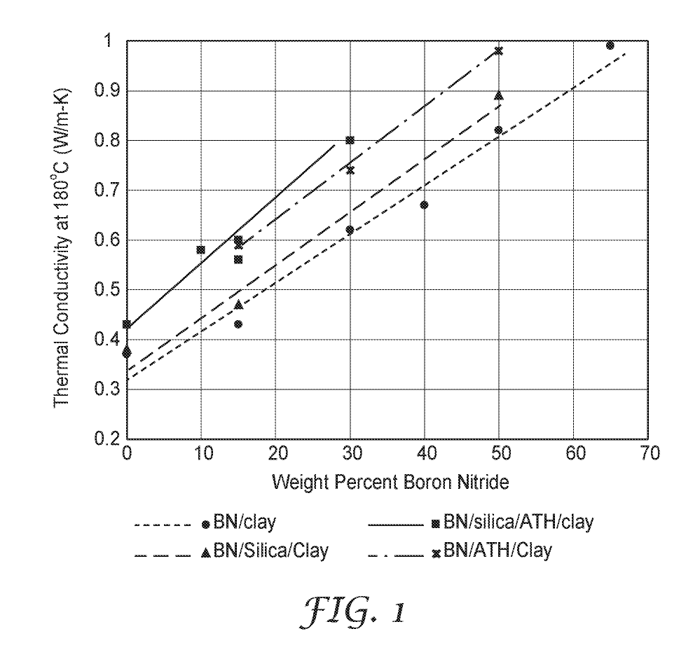

FIG. 1 is a graph which shows selected data illustrating the synergistic effects of blends of a first and a second thermally conductive fillers on the thermal conductivity of a nonwoven papers from Tables 2-5 compared with an analogous paper having a single high thermally conductive filler (i.e. boron nitride from Table 1) as a function of the volume percent of boron nitride present in the paper. Combinations boron nitride and alumina, boron nitride and silica, and boron nitride and ATH achieve higher thermal conductivities at lower loadings of boron nitride than can be obtained from paper formulations with boron nitride alone. Since boron nitride is expensive, the ability to obtain higher thermal conductivity values at lower loadings is useful.

A calculated total thermal conductivity coefficient for the exemplary electrically insulating papers comprising a combination of at least two thermally conductive fillers was equal to sum of the volume fraction of each individual component multiplied by the thermal conductivity of each individual component or kₚ=Σ (V_{f,i}×kᵢ), where kₚ is the total thermal conductivity coefficient of an exemplary paper, V_{f,i} is the volume fraction of a given component, i, present exemplary paper and kᵢ is the thermal conductivity coefficient of component i. A similar process was repeated for each of the papers represented by the comparative examples (i.e. thermally conductive papers comprising a single thermally conductive filler).

From the calculated total thermal conductivity coefficient for the exemplary paper material, a calculated relative thermal conductivity factor was calculated and normalized by the calculated total thermal conductivity coefficient for a paper containing a single thermally conductive filler (i.e. boron nitride as provided in the comparative examples. The relative thermal conductivity coefficient factor is equal to the quantity of the calculated total thermal conductivity coefficient of an exemplary paper with at least two thermally conductive fillers minus the calculated total thermal conductivity coefficient of paper with boron nitride alone divided by the calculated total thermal conductivity coefficient of paper with boron nitride.

A measured relative thermal conductivity factor for the actual measured thermal conductivity for an exemplary paper material comprising a combination of at least two thermally conductive fillers was then calculated and normalized to the measured thermally conductivity of thermally conductive papers comprising a single thermally conductive filler, boron nitride. The measured relative thermal conductivity factor for an exemplary paper material comprising a combination of at least two thermally conductive fillers was found by taking the measured thermal conductivity of one of the exemplary papers comprising at least two thermally conductive fillers and subtracting the measured thermal conductivity of paper with boron nitride as the sole thermally conductive filler and dividing by subtracting the measured thermal conductivity of paper with boron nitride as the sole thermally conductive filler at the same approximate loading of boron nitride.

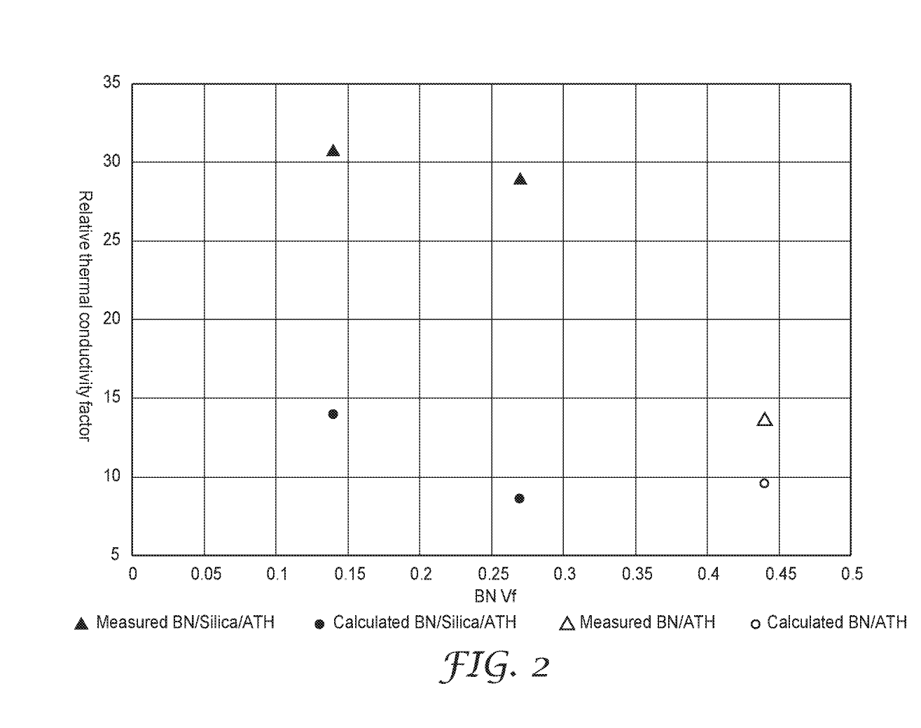

FIG. 2 compares the measured relative thermal conductivity factors and the calculated relative thermal conductivity factors at comparable volume fraction loadings of boron nitride. The graph shows that the measured relative thermal conductivity factor (triangular symbols) of the paper with at least two thermally conductive fillers is higher than the calculated relative thermal conductivity factor (circular symbols) when accounting for volume loading differences of different particle components. The solid symbols represent data for exemplary papers with a tertiary blend of thermally conductive fillers (boron nitride, fused silica, and alumina trihydrate) and open symbols represent data for exemplary papers with a binary blend of thermally conductive fillers (boron nitride and alumina trihydrate).

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof.

What we claim is:

1. A thermally conductive, electrical insulating paper comprising:
aramid fibers;
an aramid pulp;
a binder material; and
a synergistic blend of thermally conductive fillers, wherein the synergistic blend comprises a first thermally conductive filler; and a secondary thermally conductive filler.

2. The paper of claim 1, further comprising an other inorganic filler.

3. The paper of claim 2, wherein the other inorganic filler comprises at least one of kaolin clay, talc, mica, calcium carbonate, alumina trihydrate, montmorillonite, smectite, bentonite, illite, chlorite, sepiolite, attapulgite, halloysite, vermiculite, laponite, rectorite, perlite, and combinations thereof.

4. The paper of claim 1, further comprising a tertiary thermally conductive filler.

5. The paper of claim 1, wherein the first thermally conductive filler is a high thermal conductivity filler having a thermal conductivity greater than or equal to 40 W/m-K, and the second thermally conductive filler is a low thermal conductivity filler having a thermal conductivity less than 40 W/m-K.

6. The paper of claim 1, wherein the first thermally conductive filler is boron nitride and the second thermally conductive filler is at least one of silica, alumina, calcium carbonate, and alumina trihydrate.

7. The paper of claim 1, wherein the binder material is a polymer latex material, and wherein the polymer latex is at least one of an acrylic latex, an acrylic copolymer latex, a nitrile latex, and a styrene latex.

8. The paper of claim 1, wherein the thermal conductivity of the paper is greater than 0.4 W/m-K.

9. A thermally conductive, electrical insulating paper comprising:
20 wt. %-30 wt. % organic components, wherein a portion of the organic components are fibrous; and
70 wt. %-80 wt. % inorganic components wherein a portion of the inorganic component is a synergistic blend of thermally conductive fillers, wherein the synergistic blend comprises a first thermally conductive filler; and a secondary thermally conductive filler.

10. The paper of claim 9, wherein the organic components comprises a combination of polymer fibers, a polymer pulp, and binder material.

11. The paper of claim 10, wherein the polymer fibers comprise at least one of aramid fibers, polyphenylene sulfide (PPS) fibers, polyester fibers, polyamide fibers, acrylic fibers, melamine fibers, polyetheretherketone (PEEK) fibers; and binder material is a polymer latex material comprising at least one of an acrylic latex, an acrylic polymer latex a nitrile latex, and a styrene latex.

12. The paper of claim 9, wherein the organic components comprise a combination of para-aramid fibers, acrylic fibers; a para-aramid pulp and an acrylic latex binder material.

13. The paper of claim 9, wherein the inorganic components further comprise at least one of an other inorganic fillers, inorganic flame retardants, and inorganic pigments.

14. The paper of claim 9, wherein the first thermally conductive filler is a high thermal conductivity filler having a thermal conductivity greater than or equal to 40 W/m-K, and the second thermally conductive filler is a low thermal conductivity filler having a thermal conductivity less than 40 W/m-K.

15. The paper of claim 9, wherein the first thermally conductive filler is boron nitride and the second thermally conductive filler is at least one of silica, alumina, calcium carbonate, and alumina trihydrate.

16. The paper of claim 9, wherein the article is substantially cellulose free.

17. An electrical insulating material for electrical equipment, wherein the electrical insulating material comprises the paper claim 1.

18. The insulation system of claim 17, wherein the electrical equipment comprises one of a transformer, a motor, and a generator.

19. A thermally conductive insulating material, comprising:
the thermally conductive, electrical insulating paper of claim 1 laminated to a surface of a polymer film.

20. The thermally conductive insulating material of claim 19, wherein the polymer film is a thermally conductive polymer film.

21. The thermally conductive insulating material of claim 20, wherein the thermally conductive, electrical insulating paper is laminated to both surfaces of the thermally conductive polymer film.
